(19) United States
(12) Patent Application Publication
(10) Pub. No.: US 2022/0159970 A1
(43) Pub. Date: May 26, 2022

(54) COMPOUND PLANT-DERIVED MOLLUSCICIDE FOR CONTROLLING POMACEA CANALICULATA AND PREPARATION METHOD AND APPLICATION THEREOF

(71) Applicant: China Jiliang University, Hangzhou (CN)

(72) Inventors: Guangfu LIU, Hangzhou (CN); Xiaoping YU, Hangzhou (CN); Pengjun ZHANG, Hangzhou (CN); Xuping SHENTU, Hangzhou (CN); Qianqian YANG, Hangzhou (CN); Yipeng XU, Hangzhou (CN); Peiying HAO, Hangzhou (CN); Chuanlin YIN, Hangzhou (CN)

(73) Assignee: China Jiliang University, Hangzhou (CN)

(21) Appl. No.: 17/202,313

(22) Filed: Mar. 15, 2021

(30) Foreign Application Priority Data
Nov. 23, 2020 (CN) 2020113216758

(51) Int. Cl. A01N 65/12; A01N 65/08; A01N 25/22

(52) U.S. Cl. CPC A01N 65/12; A01N 25/22; A01N 65/08

(57) ABSTRACT

A compound plant-derived molluscicide for controlling Pomacea canaliculata and a preparation method and application thereof are disclosed. The compound plant-derived molluscicide is prepared from following raw materials in proportion by weight: 40-45% of water extract of Solidago canadensis L. leaves, 45-50% of water extract of Lantana camara L. roots, 0.1-0.2% of active ingredient stabilizer, and 0.1-0.2% of preservative; and a balance is ultrapure water. The disclosure has rich raw material resources, low cost, good molluscicidal effect, sustained and stable efficacy, non-toxic effect on freshwater fish, and meets the requirements of environmental protection.

### TECHNICAL FIELD

The present disclosure relates to the technical field of molluscicides for controlling harmful molluscs, and more specifically, to a compound plant-derived molluscicide for controlling Pomacea canaliculata and a preparation method and application thereof.

### BACKGROUND

Pomacea canaliculata, also known as big bottle snail and apple snail, is an international malignant pest. Pomacea canaliculata is native to the Amazon River Basin in South America and was introduced to Asia in the early 1980s. It was abandoned due to poor management and poor taste. It quickly spread to the fields, causing serious damage to rice, water bamboo and other aquatic crops in some areas. Pomacea canaliculata is a serious agricultural pest in most provinces south of the Yangtze River in China because of its strong breeding ability, rapid spreading and spreading. At present, Pomacea canaliculata is widely distributed in most provinces south of 30° N in China, including Zhejiang, Fujian, Guangdong, Hainan, Guangxi, Yunnan, Guizhou, Hunan, Jiangxi, Chongqing, Sichuan and Anhui. The density of the population is very large, which has a serious impact on agricultural production.

At present, there are many ways to control Pomacea canaliculata. Physical control includes artificial snails picking, artificial egg removal, duck turtle co culture and so on. Due to the stability of the effect, the choice of the implementation time and the cost and other factors, this control method is not suitable for large-scale use. Chemical control uses various chemicals to kill Pomacea canaliculata. At present, the control of Pomacea canaliculata is mainly based on chemical pesticides. Chemical control will cause a certain degree of pollution to the environment and high toxicity to other aquatic organisms. In addition, Pomacea canaliculata in some areas has resistance to chemical pesticides, which makes the control more difficult and costly. Some chemical pesticides can accumulate in the human body after circulation, resulting in cumulative toxicity, which brings great harm to human health. Therefore, it is urgent to research and develop new molluscicides which are safe for higher animals, fish and human beings, highly effective for Pomacea canaliculata and environmentally friendly.

Plant-derived natural drugs have incomparable advantages over chemical drugs: abundant sources, low cost, easy degradation in the natural environment and less pollution to the environment. Many scholars around the world have carried out extensive research on botanical pesticides. Zeng Kunyu et al. (2008) studied the molluscicidal effect of four invasive plants homologous to Pomacea canaliculata. Xu wubing et al. (2010) studied the effect of 16 plants on the taxis and avoidance of Pomacea canaliculata. Hu Fei et al. (2010) reported the toxic effect of the ethanol extract of Ipomoea cairica on Pomacea canaliculata. Dai Lingpeng et al. reported the toxic effect of Nerium oleander L. saponin on Pomacea canaliculata. Chen Xiaojuan et al. (2012) reported the toxic activities of 10 plant extracts against Pomacea canaliculata. The toxic effect of Alternanthera philoxeroides saponin (Wang Zhigao, 2011), Eomecon chionantha Hance herb extract (Zhou Bing et al., 2011), methanol extract of Jatropha curcas L. leaf (Wang Zhaoyu et al., 2009) and Jatropha curcas L. extract (Zhang Xiaolong et al., 2012) to Pomacea canaliculata were also studied. The above researches show that it is very potential to apply some plant extracts in nature to the development of biopesticides. In the above studies, many plant extracts are extracted with organic solvents such as ethanol and methanol, which are toxic and not friendly to the environment. In addition, a series of molluscicidal formulas are developed by combining plant extracts with chemical molluscicides. For example, the disclosure with application No. 2018115517377 discloses a composition of Pueraria peduncularis extract and niclosamide for controlling Pomacea canaliculata and application thereof; the disclosure with the application number of 2006100276017 discloses a compound molluscicide containing ginkgolic acid and a preparation method thereof; the disclosure with the application number of 2019111748748 discloses a formula of compound molluscicidal of tea saponin or oil tea cake and tetraacetaldehyde; the disclosure with the application number of 2018104527074 discloses a green molluscicide suitable for Pomacea canaliculata. These molluscicide formulations reduce the amount of chemical molluscicide, and the molluscicidal effect is better. However, the chemical molluscicides contained in the formulas disclosed by these disclosures are toxic to the environment, or toxic to aquatic organisms, or slow to take effect. Therefore, the development of a green plant molluscicide has become an important part of the current control of Pomacea canaliculata. In the present disclosure, water is used as solvent to extract various effective components of plants, and various single components are scientifically matched through precise experiments to achieve the best toxic effect

### SUMMARY

The aim of the disclosure is to provide a compound plant-derived molluscicide for controlling Pomacea canaliculata and a preparation method and application thereof. In the present disclosure, water is used as solvent to extract various effective components of plants, and various single components are scientifically matched through precise experiments to achieve the best toxic effect.

Technical solutions of the present disclosure are specifically described as follows.

In a first aspect, the disclosure provides a compound plant-derived molluscicide for controlling Pomacea canaliculate. The compound plant-derived molluscicide is prepared from following raw materials in proportion by weight: 40-45% of water extract of Solidago canadensis L. leaves, 45-50% of water extract of Lantana camara L. roots, 0.1-0.2% of active ingredient stabilizer, and 0.1-0.2% of preservative; and a balance is ultrapure water.

Preferably, the active ingredient stabilizer is Tween 80, and the preservative is sorbic acid or sodium benzoate.

In a second aspect, the disclosure provides a preparation method of the compound plant-derived molluscicide, including:
(1) collecting fresh Solidago canadensis L. leaves and fresh Lantana camara L. roots respectively, washing and draining;
(2) cutting the above drained Solidago canadensis L. leaves and Lantana camara L. roots into 0.5-1 cm segments, respectively;
(3) putting the Solidago canadensis L. leaf segments and the Lantana camara L. root segments prepared in step (2) into a 200-300 mesh crusher for crushing, respectively;
(4) weighing the crushed Solidago canadensis L. leaf material and the crushed Lantana camara L. root material prepared in step (3) and adding with sterilized water in a volume ratio of 1:4-5 to each; putting the Solidago canadensis L. leaf material added with sterilized water and the Lantana camara L. root material added with sterilized water into a refrigerator at 4 ° C. overnight, grinding the Solidago canadensis L. leaf material and the Lantana camara L. root material after standing, and filtering the grinding liquid respectively with sterile gauze to obtain water extract of Solidago canadensis L. leaves and water extract of Lantana camara L. roots;
(5) taking the water extract of Solidago canadensis L. leaves and the water extract of Lantana camara L. roots in a formula amount and mixing, adding sterilized water into the mixed water extract in a prescribed amount for dilution, and then adding with the active ingredient stabilizer and the preservative in a formula amount; after mixing evenly, standing overnight, and obtaining the compound plant-derived molluscicide by filtration.

Each component used in the molluscicide in the disclosure is the water extract of the leaves or roots of natural plants. The plant-derived molluscicides is environmental friendly, non-toxic to the environment, abundant in sources and low in cost. Solidago canadensis L. is a plant of Compositae of Platycoidea, which contains saponins in the whole grass and causes paralysis and dyskinesia due to accidental ingestion by livestock. Lantana camara L. is a plant of Verbenaceae of Dicotyledons, whose whole plants and roots are poisonous.

In a third aspect, the disclosure provides an application of the compound plant-derived molluscicide of claim 1 as a molluscicide for Pomacea canaliculate. Under the condition of room temperature of 26-30 ° C., the compound plant-derived molluscicide of the disclosure is prepared into a mixed agent with a concentration greater than 5 g/L to poison Pomacea canaliculata.

Typically, but not by way of limitation, the concentration of the mixed agent can be 40 g/L, 30 g/L, 20 g/L, 10 g/L, 5 g/L and other different concentrations.

Compared with the prior art, the disclosure has the following beneficial effects.
(1) The materials used in the disclosure are natural plants with rich sources, low cost, easy degradation in the natural environment, and low pollution to the environment. The preparation method of the compound plant-derived molluscicide is simple and convenient to operate in the field.
(2) It opens up a new way for the resource utilization of plants.
(3) The compound plant-derived molluscicide has a high-efficiency molluscicidal effect and a quick onset, which is equivalent to that of the commercially available chemical molluscicide niclosamide wettable powder (see Table 2).
(4) The compound plant-derived molluscicide is environmentally friendly, non-toxic to the environment, non-toxic to humans, animals and other aquatic organisms.

### DETAILED DESCRIPTION OF EMBODIMENTS

In the following, the present disclosure will be further described with reference to specific embodiments, but the scope of the disclosure is not limited thereto.

### Embodiment 1

Preparation of Water Extracts the Plants
(1) Fresh Solidago canadensis L. leaves and fresh Lantana camara L. roots were collected respectively. After collection, they were washed and the surface water was drained.
(2) The above drained Solidago canadensis L. leaves and Lantana camara L. roots were cut into 0.5-1 cm segments, respectively.
(3) The Solidago canadensis L. leaf segments and the Lantana camara L. root segments prepared in step (2) were put into a 200-300 mesh crusher for crushing, respectively.
(4) 50 g of each crushed plant material prepared in step (3) were weighed, and sterilized water in a volume ratio of 1:5 was added into each; each crushed plant material added with sterilized water was put into a refrigerator at 4° C. overnight; each plant material was ground after standing, and the grinding liquid was filtered with sterile gauze to obtain water extract of each plant.

### Embodiment 2

Preparation of 1000 g Compound Plant-Derived Molluscicide

The formula was: 400 g of the water extract of Solidago canadensis L. leaves, 450 g of the water extract of Lantana camara L. roots, 1 g of the active ingredient stabilizer, 1 g of the preservative, and 148 g of ultrapure water.

The water extracts of Solidago canadensis L. leaves and Lantana camara L. roots were taken in the above formula amount, the formula amount of sterile water was added for dilution, then Tween 80 as the active ingredient stabilizer and the preservative (in this embodiment, it was sorbic acid) were added in the formula amount. The mixture was mixed evenly and stood overnight. Then the compound plant-derived molluscicide was obtained by filtration, and was put in a refrigerator for standby after labeling.

### Embodiment 3

Preparation of 1000 g Compound Plant-Derived Molluscicide

The formula was: 450 g of the water extract of Solidago canadensis L. leaves, 500 g of the water extract of Lantana camara L. roots, 2 g of the active ingredient stabilizer, 2 g of the preservative, and 46 g of ultrapure water.

The water extract of Solidago canadensis L. leaves and Lantana camara L. roots were taken in the above formula amount, the formula amount of sterile water was added for dilution, then Tween 80 as the active ingredient stabilizer and the preservative (in this embodiment, it was sodium benzoate) were added in the formula amount. The mixture was mixed evenly and stood overnight. Then the compound plant-derived molluscicide was obtained by filtration, and was put in a refrigerator for standby after labeling.

### Embodiment 4 Molluscicidal Test

4.1 Molluscicidal Effect of the Two Water Extracts

4.1.1 Pomacea canaliculata for Test

All the Pomacea canaliculata snails were collected from paddy fields and nearby ditches. The Pomacea canaliculata snails were collected, cleaned and domesticated in a 40 cm×25 cm×28 cm feeding vat in greenhouse. In the test, healthy Pomacea canaliculata snails with similar height and weight were selected as the test objects, and they were not fed during the test.

4.1.2 Test solution: water extract of each plant prepared in embodiment 1. The water extracts of each plant were diluted into 40 g/L, 30 g/L, 20 g/L, 10 g/L and 5 g/L with ultrapure water. Meanwhile, ultrapure water was used as a blank control and niclosamide wettable powder was as a positive control.

4.1.3 Test method: 600 ml of each component solution with concentration of 40 g/L, 30 g/L, 20 g/L, 10 g/L and 5 g/L was taken into a 1000 ml beaker, respectively. At the same time, ultrapure water was used as a blank control, and niclosamide wettable powder was used as a positive control. 20 Pomacea canaliculata snails were put into each beaker without feeding. The mouth of the beaker was covered with nylon net. The death number of Pomacea canaliculata snails in each beaker was checked every 24 hours, and the mortality rate of Pomacea canaliculata snails in different treatments at the corresponding time was calculated. The total observation time was 144 hours. The temperature was 26° C.±1° C. during the test. Three replicates were set for each treatment.

4.1.4 Identification standard of Pomacea canaliculata: after putting Pomacea canaliculata snails into different concentrations of sample solution, the suspected dead snails in each treatment were taken out every 24 hours and put into dechlorinated water for observation. The snails floating on the water or suspending in the water within 24 hours without movement and response to external stimulation were regarded as dead snails.

4.1.5 Data Processing and Analysis

Excel and SPSS 20.0 software were used to analyze the test data.

4.1.6 Result Analysis

TABLE 1
Molluscicidal effect of water extracts of two plants

| | | Mortality rate (%) | | | | | |
|---|---|---|---|---|---|---|---|
| | | Poison time | | | | | |
| Group | | 24 h | 48 h | 72 h | 96 h | 120 h | 144 h |
| 40 g/L | Water | 36.7 ± 1.4a | 52.3± 2.1a | 55.7 ± 1.7a | 61.3 ± 1.2b | 82.3 ± 1.3b | 91.0 ± 1.4b |
| | extract of | | | | | | |
| | Solidago | | | | | | |
| | canadensis | | | | | | |
| | L. leaves | | | | | | |
| | Water | 41.3 ± 1.3a | 50.3 ± 1.4a | 61.7 ± 1.3b | 76.4± 1.1b | 85.0 ± 0b | 85.0 ± 0 |
| | extract of | | | | | | |
| | Lantana | | | | | | |
| | camara L. | | | | | | |
| | roots | | | | | | |
| 30 | Water | 28.3 ± 2.1a | 31.7 ± 1.7a | 53.3 ± 1.7a | 61.7 ± 1.4b | 80.3 ± 0b | 94.3 ± 0b |
| 30 g/L | extract of | | | | | | |
| | Solidago | | | | | | |
| | canadensis | | | | | | |
| | L. leaves | | | | | | |
| | Water | 38.3 ± 1.5a | 45.3 ± 1.4a | 56.7 ± 1.3a | 70.4 ± 1.1b | 84.3 ± 0b | 85.0 ± 0b |
| | extract of | | | | | | |
| | Lantana | | | | | | |
| | camara L. | | | | | | |
| | roots | | | | | | |
| 20 g/L | Water | 22.3 ± 2.2a | 26.3 ± 1.6a | 43.3 ± 1.3a | 51.7 ± 1.8a | 72.3 ± 1.2b | 84.3 ± 1.2b |
| | extract of | | | | | | |
| | Solidago | | | | | | |
| | canadensis | | | | | | |
| | L. leaves | | | | | | |
| | Water | 28.3 ± 1.7a | 35.3 ± 1.3a | 46.7 ± 1.4a | 60.3 ± 1.2b | 74.3 ± 1.5b | 75.0 ± 0b |
| | extract of | | | | | | |
| | Lantana | | | | | | |
| | camara L. | | | | | | |
| | roots | | | | | | |
| 10 g/L | Water | 15.3 ± 2.1c | 16.3 ± 1.7c | 23.3 ± 1.4a | 51.3 ± 1.7a | 62.3 ± 1.5b | 74.3 ± 1.3b |
| | extract of | | | | | | |
| | Solidago | | | | | | |
| | canadensis | | | | | | |
| | L. leaves | | | | | | |
| | Water | 19.3 ± 1.6c | 30.3 ± 1.4a | 45.7 ± 1.5a | 50.3 ± 1.3a | 64.3 ± 1.6b | 65.0 ± 0b |
| | extract of | | | | | | |
| | Lantana | | | | | | |
| | camara L. | | | | | | |
| | roots | | | | | | |
| 5 g/L | Water | 8.3 ± 1.1c | 15.3 ± 1.5c | 18.3 ± 1.4c | 21.3 ± 1.7a | 42.3 ± 1.6a | 44.3 ± 1.4a |
| | extract of | | | | | | |
| | Solidago | | | | | | |
| | canadensis | | | | | | |
| | L. leaves | | | | | | |
| | Water | 18.3 ± 1.6c | 25.3 ± 1.4a | 36.7 ± 1.5a | 45.3 ± 1.3a | 55.3 ± 1.6a | 60.0 ± 0b |
| | extract of | | | | | | |
| | Lantana | | | | | | |
| | camara L. | | | | | | |
| | roots | | | | | | |

| | | | | | | |
|---|---|---|---|---|---|---|
| Bland control | 0 ± 0a | 0 ± 0 a | 0 ± 0 a | 0 ± 0 a | 0 ± 0 a | 0 ± 0 a |
| Niclosamide | | | | | | |
| wettable powder | 64.8 ± 1.7b | 80.3 ± 1.5b | 100 ± 0c | 100 ± 0c | 100 ± 0c | 100 ± 0c |
| (1.25 mg/L) | | | | | | |

It can be seen from Table 1 that the water extracts of two plants had certain molluscicidal effect on Pomacea canaliculata, and the mortality of Pomacea canaliculata increased with the increase of water extract concentration and treatment time. It can be seen from table 1 that the molluscicidal effect of the water extracts of two plants in a short time was not ideal. Although the mortality of Pomacea canaliculata in each group increased with the extension of treatment time, the molluscicidal effect was still weaker than that of the control drug niclosamide wettable powder (P<0.05). Within 24 hours, the water extract of Lantana camara L. roots with 40 g/L concentration had the best toxic effect on Pomacea canaliculata, and the mortality rate was 41.3%. Within 48 hours, the killing rate of 40 g/L water extracts of two plants to Pomacea canaliculata was more than 50%.

4.2 Molluscicidal Effect of Compound Water Extract

The water extracts of two plants were mixed according to the formula amount (according to the formula amount of embodiment 2 and embodiment 3 respectively), and the molluscicidal effect of the water extracts of two plant was detected. The specific test method was the same as part 4.1 of embodiment 4. The results (Table 2) showed that the toxic effect of the mixture of water extracts of two plants on Pomacea canaliculata was higher than that of single water extract in corresponding concentration of (Table 1), and the mortality rate of Pomacea canaliculata increased with the extension of treatment time. Among all kinds of concentrations, 40 g/L corresponded to the best molluscicidal effect. The half mortality rate appeared within 24 hours, and the mortality rate of Pomacea canaliculata reached 100% within 72 hours. The molluscicidal effect was similar to that of niclosamide wettable powder.

TABLE 2
Molluscicidal effect of water extracts of two plants

| | | mortality rate (%) | | | | | |
|---|---|---|---|---|---|---|---|
| | | Poison time | | | | | |
| Group | | 24 h | 48 h | 72 h | 96 h | 120 h | 144 h |
| Embodiment 2 | 40 g/L | 51.7 ± 1.4b | 70.3 ± 2.1b | 100 ± 0c | 100 ± 0c | 100 ± 0c | 100 ± 0c |
| | 30 g/L | 38.3 ± 2.1a | 51.7 ± 1.7b | 83.3 ± 1.7b | 91.7 ± 1.4b | 100 ± 0c | 100 ± 0c |
| | 20 g/L | 23.3 ± 1.1a | 46.7 ± 1.4a | 81.7 ± 1b | 91.7 ± 1.6b | 100 ± 0c | 100 ± 0c |
| | 10 g/L | 11.7 ± 1.7a | 19.3 ± 1.2a | 31.3 ± 1.3a | 57.3 ± 1.8b | 83.3 ± 1.7b | 100 ± 0c |
| | 5 g/L | 8.3 ± 1.7c | 15.7 ± 1.4a | 31.7 ± 1.5a | 45 ± 0a | 85.7 ± 1.1b | 98.7 ± 1.7c |
| Embodiment 3 | 40 g/L | 55.3 ± 1.7b | 75 ± 1.4b | 100 ± 0c | 100 ± 0c | 100 ± 0c | 100 ± 0c |
| | 30 g/L | 45.7 ± 1.3b | 58.7 ± 1.8b | 88.3 ± 1.2b | 100 ± 0c | 100 ± 0c | 100 ± 0c |
| | 20 g/L | 37.7 ± 1.7a | 48.3 ± 1.4b | 83.3 ± 1.5b | 96.3 ± 1.4c | 100 ± 0c | 100 ± 0c |
| | 10 g/L | 16.7 ± 1.6a | 40.0 ± 0b | 38.3 ± 1.5b | 63.3 ± 1.7b | 86.7 ± 1.7b | 100 ± 0c |
| | 5 g/L | 15.3 ± 1.8a | 22.3 ± 1.3a | 34.3 ± 1.2a | 45.0 ± 0b | 81.7 ± 1.5b | 100 ± 0c |

| | | | | | | |
|---|---|---|---|---|---|---|
| Blank control | 0 ± 0a | 0 ± 0 a | 0 ± 0 a | 0 ± 0 a | 0 ± 0 a | 0 ± 0 a |
| (ultrapure water) | | | | | | |
| Niclosamide wettable | 64.7 ± 2.4b | 80.3 ± 1.7b | 100 ± 0c | 100 ± 0c | 100 ± 0c | 100 ± 0c |
| powder (1.25 mg/L) | | | | | | |

### Embodiment 5

5.1 Test Animals

All the Pomacea canaliculata snails were collected from paddy fields and nearby ditches. Pomacea canaliculata snails was collected, cleaned and domesticated in a 40 cm×25 cm×28 cm feeding vat in greenhouse. In the test, healthy Pomacea canaliculata snails with similar height and weight were selected as the test objects, and they were not fed during the test.

5.2 Test Solution

The compound plant-derived molluscicide with a concentration of 40g/L, which was prepared in embodiment 2 and embodiment 3 and proved to be highly toxic to Pomacea canaliculata by test, was as the test solution. Meanwhile, ultrapure water was used as blank control.

5.3 Test method: 600 ml of the test solution with concentration of 40 g/L was taken into a 1000 ml beaker. At the same time, ultrapure water was used as a blank control. 20 Pomacea canaliculata snails were put into each beaker without feeding. The mouth of the beaker was covered with nylon net. The death number of Pomacea canaliculata snails in each beaker was checked every 24 hours, and the mortality rate of Pomacea canaliculata snails in different treatments at the corresponding time was calculated. The total observation time was 144 hours. The temperature was 26° C.±1° C. during the test. Three replicates were set for each treatment.

At the same time, 600 ml of the test solution with concentration of 40 g/L was taken into a 1000 ml beaker, and ultrapure water was used as a blank control. 20 healthy red carp (7-8cm in length) were put into each beaker and raised as usual. The death number of red carp in each beaker was checked every 24 hours. The total observation time was 72 hours. The temperature was 26° C.±1° C. during the test. Three replicates were set for each treatment.

TABLE 3
Toxicity test of freshwater fish
mortality rate %

| | Poison time | | |
|---|---|---|---|
| Group | 24 h | 48 h | 72 h |
| Red carp | 0 | 0 | 0 |
| Embodiment 2 | 51.7 ± 1.4 | 70.3 ± 2.1 | 100 ± 0 |
| (40 g/L) | | | |
| Embodiment 2 | 55.3 ± 1.7 | 75 ± 1.4 | 100 ± 0 |
| (40 g/L) | | | |
| Blank control (ultrapure water) | 0 ± 0a | 0 ± 0a | 0 ± 0a |

We claim:

1. A compound plant-derived molluscicide prepared from following raw materials in proportion by weight:
40-45% of water extract of Solidago canadensis L. leaves;
45-50% of water extract of Lantana camara L. roots;
0.1-0.2% of active ingredient stabilizer;
0.1-0.2% of preservative; and
the balance being ultrapure water.

2. The compound plant-derived molluscicide of claim 1, wherein the active ingredient stabilizer is Tween 80, and the preservative is sorbic acid or sodium benzoate.

3. The compound plant-derived molluscicide of claim 1, wherein a preparation method of the compound plant-derived molluscicide comprises:
(1) collecting fresh Solidago canadensis L. leaves and fresh Lantana camara L. roots respectively, washing and draining;
(2) cutting the above drained Solidago canadensis L. leaves and Lantana camara L. roots into 0.5-1 cm segments, respectively;
(3) putting the Solidago canadensis L. leaf segments and the Lantana camara L. root segments prepared in step (2) into a 200-300 mesh crusher for crushing, respectively;
(4) weighing the crushed Solidago canadensis L. leaf material and the crushed Lantana camara L. root material prepared in step (3) and adding with sterilized water in a volume ratio of 1:4-5 to each; putting the Solidago canadensis L. leaf material added with sterilized water and the Lantana camara L. root material added with sterilized water into a refrigerator at 4° C. overnight, grinding the Solidago canadensis L. leaf material and the Lantana camara L. root material after standing, and filtering the grinding liquid respectively with sterile gauze to obtain water extract of Solidago canadensis L. leaves and water extract of Lantana camara L. roots;
(5) taking the water extract of Solidago canadensis L. leaves and the water extract of Lantana camara L. roots in a prescribed amount and mixing, adding sterilized water into the mixed water extract in a prescribed amount for dilution, and then adding with the active ingredient stabilizer and the preservative in a formula amount; after mixing evenly, standing overnight, and obtaining the compound plant-derived molluscicide by filtration.

4. A preparation method of the compound plant-derived molluscicide, comprising:
(1) collecting fresh Solidago canadensis L. leaves and fresh Lantana camara L. roots respectively, washing and draining;
(2) cutting the above drained Solidago canadensis L. leaves and Lantana camara L. roots into 0.5-1 cm segments, respectively;
(3) putting the Solidago canadensis L. leaf segments and the Lantana camara L. root segments prepared in step (2) into a 200-300 mesh crusher for crushing, respectively;
(4) weighing the crushed Solidago canadensis L. leaf material and the crushed Lantana camara L. root material prepared in step (3) and adding with sterilized water in a volume ratio of 1:4-5 to each; putting the Solidago canadensis L. leaf material added with sterilized water and the Lantana camara L. root material added with sterilized water into a refrigerator at 4° C. overnight, grinding the Solidago canadensis L. leaf material and the Lantana camara L. root material after standing, and filtering the grinding liquid respectively with sterile gauze to obtain water extract of Solidago canadensis L. leaves and water extract of Lantana camara L. roots;
(5) taking the water extract of Solidago canadensis L. leaves and the water extract of Lantana camara L. roots in a formula amount and mixing, adding sterilized water into the mixed water extract in a formula amount for dilution, and then adding with the active ingredient stabilizer and the preservative in a formula amount; after mixing evenly, standing overnight, and obtaining the compound plant-derived molluscicide by filtration.

5. The preparation method of the compound plant-derived molluscicide of claim 1, wherein in the step (5), in terms of mass percentage, the formula amount of each component is: 40-45% of the water extract of Solidago canadensis L. leaves, 45-50% of the water extract of Lantana camara L. roots, 0.1-0.2% of the active ingredient stabilizer, and 0.1-0.2% of the preservative; and a balance is ultrapure water.

6. An application of the compound plant-derived molluscicide of claim 1 as a molluscicide for Pomacea canaliculate.

7. The application of claim 6, wherein the compound plant-derived molluscicide is formulated into a mixed agent with a concentration of 5-40 g/L and applied under 26-30° C.
